(19) United States
(12) Patent Application Publication
(10) Pub. No.: US 2012/0281723 A1
(43) Pub. Date: Nov. 8, 2012

(54) WAVELENGTH-TUNABLE EXTERNAL CAVITY LASER

(75) Inventors: Su Hwan OH, Seo-gu (KR); Ki-Hong Yoon, Yuseong-gu (KR); Kisoo Kim, Yuseong-gu (KR)

(73) Assignee: ELECTRONICS AND TELECOMMUNICATIONS RESEARCH INSTITUTE, Daejeon (KR)

(21) Appl. No.: 13/461,118

(22) Filed: May 1, 2012

(30) Foreign Application Priority Data
May 6, 2011 (KR) 10-2011-0043117

(51) Int. Cl. H01S 3/10

(52) U.S. Cl. 372/20

(57) ABSTRACT

Provided is a wavelength-tunable external cavity laser. The wavelength-tunable external cavity laser includes a housing, a planar lightwave circuit (PLC) device disposed within the housing, a pump light source disposed at a side of the PLC device within the housing, and a modulation part disposed at the other side of the PLC device facing the pump light source within the housing.

### CROSS-REFERENCE TO RELATED APPLICATIONS

This U.S. non-provisional patent application claims priority under 35 U.S.C. §119 of Korean Patent Application No. 10-2011-0043117, filed on May 6, 2011, the entire contents of which are hereby incorporated by reference.

### BACKGROUND OF THE INVENTION

The present invention disclosed herein relates to a laser, and more particularly, to a wavelength-tunable external cavity laser.

Next generation metro-access all-optical networks are targeted at construction of next generation broadband access networks which provide end-to-end optical wavelength services and remove the bottleneck phenomenon of an electrical switch due to an increase of subscribers and traffics. Optical components used in such an all-optical network are in an early stage in development, and thus optical component markets can be recognized as emerging markets having great growth potential. Accordingly, when the optical components are early developed by being organically connected to a system, it may be possible to achieve initial world market dominance. For example, a planar lightwave circuit-external cavity laser (PLC-ECL) may realize a wavelength-tunable laser for subscriber having superior mass productivity. Also, the PLC-ECL may have a data rate of about 2.5 Gbps or more in a single channel to realize next generation advanced FTTH networks, and simultaneously, be adequate in terms of reliability/low prices.

### SUMMARY OF THE INVENTION

The embodiment of the inventive concept provides a wavelength-tunable external cavity laser outputting a high speed modulation signal of about 0.25 Gbps to about 10 Gbps.

The embodiment of the inventive concept also provides a wavelength-tunable external cavity laser which improves coupling performance and stability of optical devices.

Embodiments of the inventive concept provide wavelength-tunable external cavity lasers comprising: a housing; a planar lightwave circuit (PLC) device disposed within the housing; a pump light source disposed at a side of the PLC device within the housing; and a modulation part disposed at the other side of the PLC device facing the pump light source within the housing.

In some embodiments, the housing may comprise first to third housings which respectively surround the pump light source, the PLC device, and the modulation part.

In other embodiments, the wavelength-tunable external cavity lasers may further comprise a RF (radio frequency) connector which transmits a RF signal into the modulation part and is coupled to the third housing.

In still other embodiments, the wavelength-tunable external cavity lasers may further comprise: a RF lead frame connecting the RF connector to the modulation part within the third housing; and an impedance matching resistor connected to the RF lead frame.

In even other embodiments, the modulation part may comprise an EA modulator.

In yet other embodiments, the modulation part may further comprise an SOA (semiconductor optical amplifier) monolithically integrated with the EA modulator.

In further embodiments, the optical amplifier may comprise an input perpendicular to an extension line from the pump light source to the PLC device and an output titled with respect to the extension line.

In still further embodiments, the modulation part may further comprise anti-reflection coating layers respectively disposed on the peripheries of both sides facing each other of the SOA and the EA modulator.

In even further embodiments, the modulation part may further comprise a thermoelectric cooler (TEC) and a thermistor to constantly maintain temperatures of the SOA and the EA modulator.

In yet further embodiments, the pump light source may comprise a thermo-optic (TO)-can package comprising a 2-section superluminescent diode (SLD) disposed on a package frame.

In much further embodiments, the first housing may comprise a package cap surrounding the package frame and the 2-section SLD disposed on the package frame.

In still much further embodiments, the 2-section SLD may comprise a gain region and a micro tuning region.

In even much further embodiments, the gain region and the micro tuning region may be tilted at an angle of about 5° to about 15°.

In yet much further embodiments, the TO-can package may comprise a mirror changing a traveling path of pump light from the 2-section SLD to the PLC device.

In even still mush further embodiments, the PLC device may comprise a polymer waveguide comprising a Bragg grating.

In even yet much further embodiments, the housing may comprise a first housing surrounding the pump light source and a fourth housing surrounding the PLC device and the modulation part.

### BRIEF DESCRIPTION OF THE DRAWINGS

The accompanying drawings are included to provide a further understanding of the embodiment of the inventive concept, and are incorporated in and constitute a part of this specification. The drawings illustrate exemplary embodiments of the inventive concept and, together with the description, serve to explain principles of the present invention. In the drawings:

FIGS. 1 and 2 are schematic cross-sectional diagram and floor plan views of a wavelength-tunable external cavity laser (ECL) according to an embodiment of the inventive concept, respectively;

FIG. 3A is a graph illustrating a reflectance according to a frequency (wavelength) of laser beam in a Bragg grating;

FIG. 3B is a graph illustrating a Fabry-Perot mode of ECL

FIG. 3C is a graph illustrating a transmittance according to the frequency (wavelength) of the laser beam lased in the Bragg grating;

FIG. 4 is graphs illustrating wavelength-tunable characteristics of the laser beam shown in FIGS. 3A to 3C;

FIG. 5 is a view illustrating wavelength-tunable characteristics of laser beam obtained from resonant frequencies of FIG. 4;

FIGS. 6A and 6B are views of a modulation part;

FIGS. 7 and 8 are coupled floor plan and separated floor plan views of a wavelength-tunable external cavity laser according to an application example of the present invention;

FIG. 9 is a plan view illustrating a pump light source of a TO-can package of FIG. 7;

FIG. 10 is a side view illustrating a pump light source of a TO-can package different from that of FIG. 9;

FIG. 11 is a perspective view illustrating a PLC device of FIG. 7; and

FIG. 12 is a plan view of a wavelength-tunable external cavity laser according to another application example of the present invention.

### DETAILED DESCRIPTION OF PREFERRED EMBODIMENTS

Preferred embodiments of the inventive concept will be described below in more detail with reference to the accompanying drawings. Advantages and features of the present invention, and implementation methods thereof will be clarified through following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Like reference numerals refer to like elements throughout.

In the following description, the technical terms are used only for explaining a specific exemplary embodiment while not limiting the inventive concept. The terms of a singular form may include plural forms unless specifically mentioned. The meaning of ‘comprises’ and/or ‘comprising’ specifies an element, a process, an operation and/or a device but does not exclude other elements, processes, operations and/or devices.

Since preferred embodiments are provided below, the order of the reference numerals given in the description is not limited thereto. In the specification, it will be understood that when a layer (or film) is referred to as being ‘on’ another layer or substrate, it can be directly on the other layer or substrate, or intervening layers may also be present.

Additionally, the embodiment in the detailed description will be described with sectional views as ideal exemplary views of the present invention. In the figures, the dimensions of layers and regions are exaggerated for clarity of illustration. Accordingly, shapes of the exemplary views may be modified according to manufacturing techniques and/or allowable errors. Therefore, the embodiments of the inventive concept are not limited to the specific shape illustrated in the exemplary views, but may include other shapes that may be created according to manufacturing processes. For example, an etched region illustrated as a rectangle may have rounded or curved features. Areas exemplified in the drawings have general properties, and are used to illustrate a specific shape of a semiconductor package region. Thus, this should not be construed as limited to the scope of the present invention.

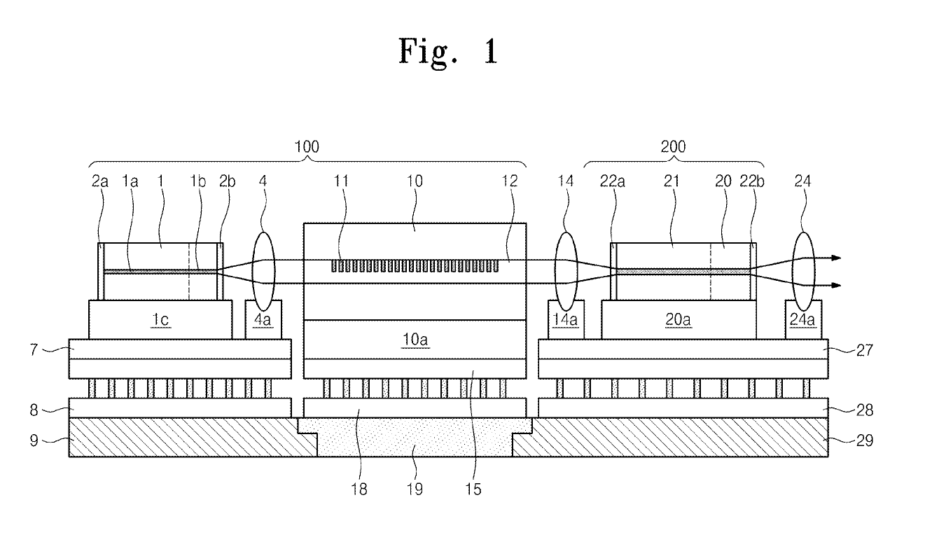

FIGS. 1 and 2 are schematic cross-sectional diagram and floor plan views of a wavelength-tunable ECL according to an embodiment of the inventive concept, respectively.

Referring to FIG. 1, a wavelength-tunable ECL according to the embodiment of the inventive concept may include a laser oscillation part 100 and a modulation part 200. The laser oscillation part 100 may include a 2-section SLD 1 and a planar lightwave circuit (PLC) device 10. The 2-section SLD 1 may include a gain region 1a and a micro tuning region 1b. The gain region 1a and the micro tuning region 1b may be tilted at an angle of about 5° to about 15°. The more the titled angle of the gain region 1a and the micro tuning region 1b is increased, the more the reflection of pump light at an anti-reflection coating layer 2b is decreased. A high-reflection coating layer 2a may reflect about 90% or more of the pump light. The gain region 1a may include a gain material which oscillates the pump light by current applied from the outside. A lasing wavelength of laser beam may be finely adjusted in the micro tuning region 1b. The 2-section SLD 1 may include the high-reflection coating layer 2a and the anti-reflection coating layer 2b which are respectively disposed on both sides of the gain region 1a and the micro tuning region 1b.

The 2-section SLD 1 may be supported by a first support block 1c and a first sub-mount 7 within a first housing 9, and the PLC device 10 may be supported by a second support block 10a and a second sub-mount 15 within a second housing 19. A first lens 4 may be supported by a first lens support block 4a and the first sub-mount 7 within the first housing 9 between the 2-section SLD 1 and the PLC device 10. A first thermoelectric cooler (TEC) 8 may be disposed between the first housing 9 and the first sub-mount 7. The first TEC 8 may constantly maintain a temperature of the 2-section SLD 1.

The PLC device 10 may include a polymer waveguide 12 in which a Bragg grating 11 is disposed. The polymer waveguide 12 may include a polymer having an effective refractive index of about 1.39 and an effective refractive index difference of about 0.019. The polymer has a thermo-optic (TO) coefficient of about 2.636×10−4/° C. Since the polymer has a relatively large TO coefficient when compared to that of an inorganic component such as silica, the polymer has a relatively large variable characteristic in a refractive index in comparison with an applied power. Thus, since the polymer waveguide 12 has a large reflection peak change depending on a temperature, the PLC device 10 may oscillate easily wavelength-tunable laser beam. The PLC device 10 may be fixed by the second support block 10a. The PLC device may be adjusted in temperature by a second TEC 18 disposed on the second housing 19.

The modulation part 200 may include a semiconductor optical amplifier (SOA) 21 and an EA modulator 20 which are monolithically integrated with each other.

An input and output of the SOA 21 may be tilted at angle of about 5° to about 15° from an extension line of the 2-section SLD 1 and the PLC device 10. The modulation part 200 may include anti-reflection coating layers 22a and 22b respectively disposed on front and rear ends of the SOA 21 and the EA modulator 20 to prevent the reflection of the propagation laser beam. The SOA 21 and the EA modulator 20 may be fixed to a third support block 20a and a third sub-mount 27. The optical amplifier 21 and the modulator 20 may be maintained at a constant temperature by a third TEC 28 between the third sub-mount 27 and the third housing 29. A second lens 14 may be disposed between the PLC device 10 and the modulation part 200. Also, a third lens 24 may be disposed at a rear side of the EA modulator 20 and the anti-reflection coating layer 22b. The second and third lenses 14 and 24 may be fixed to second and third lens support blocks 14a and 24a disposed on the third sub-mount 27, respectively. Each of the second and third lenses 14 and 24 may include an aspherical convex lens. The propagation laser beam is modulated at the modulation part 200, and the modulated laser beam may be outputted through an optical fiber 25.

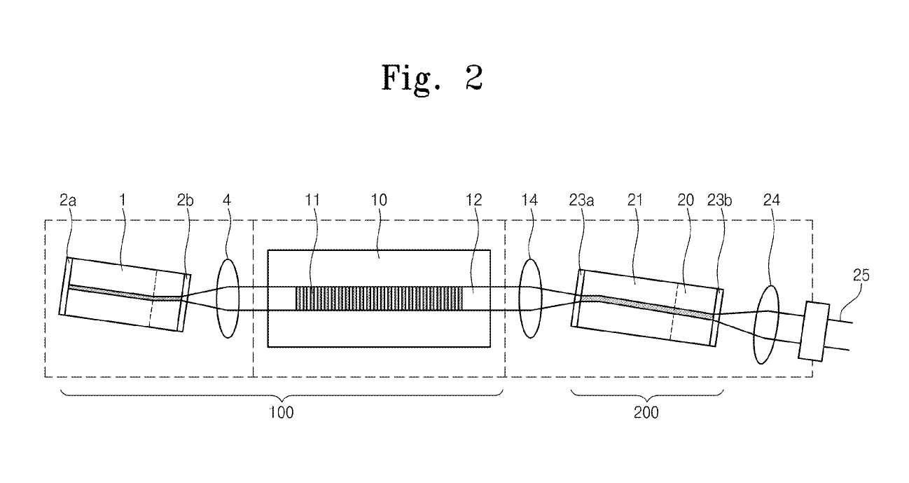

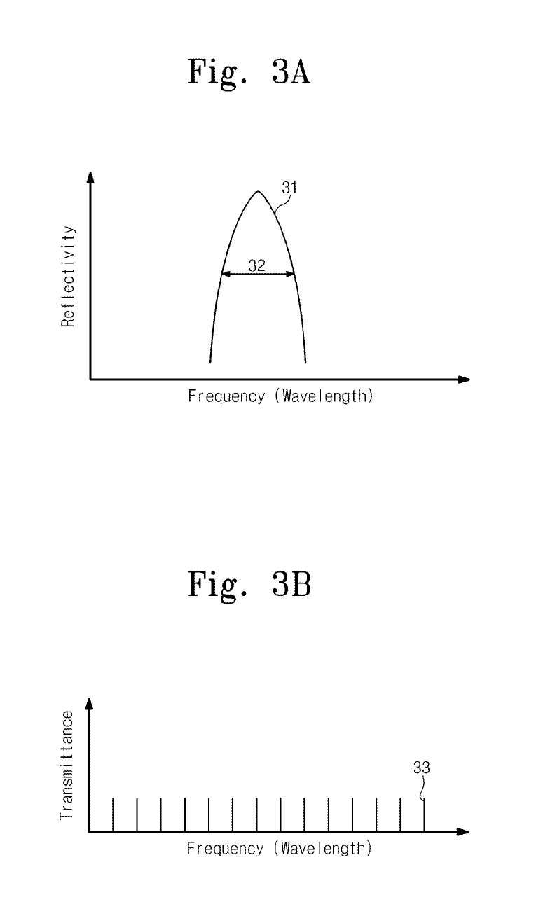

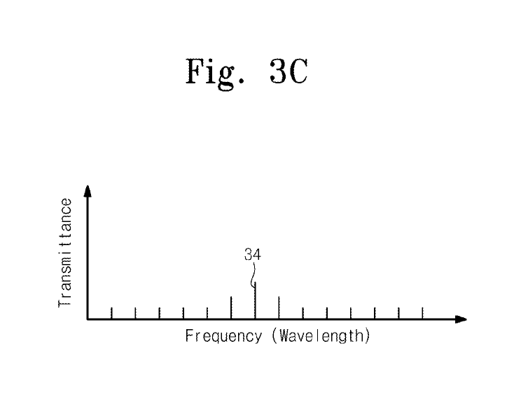

FIG. 3A is a graph illustrating a reflectance according to a frequency (wavelength) of laser beam in Bragg grating. FIG. 3B is a graph illustrating a Fabry-Perot mode of the ECL. FIG. 3C is a graph illustrating a transmittance according to the frequency (wavelength) of the laser beam oscillated in the Bragg grating.

Referring to FIGS. 1 to 3C, the Bragg grating 11 having a first peak 31 with a high reflectivity at a specific frequency (wavelength). The Bragg grating 11 may have the 3-dB bandwidth 32 of less than 0.3 nm. A spacing of Fabry-Perot mode 33 may be varied by a cavity length of the ECL. The lasing wavelength of ECL 34 may determine in agreement with the Fabry-Perot mode 33 in first reflection peak 31 of Bragg grating.

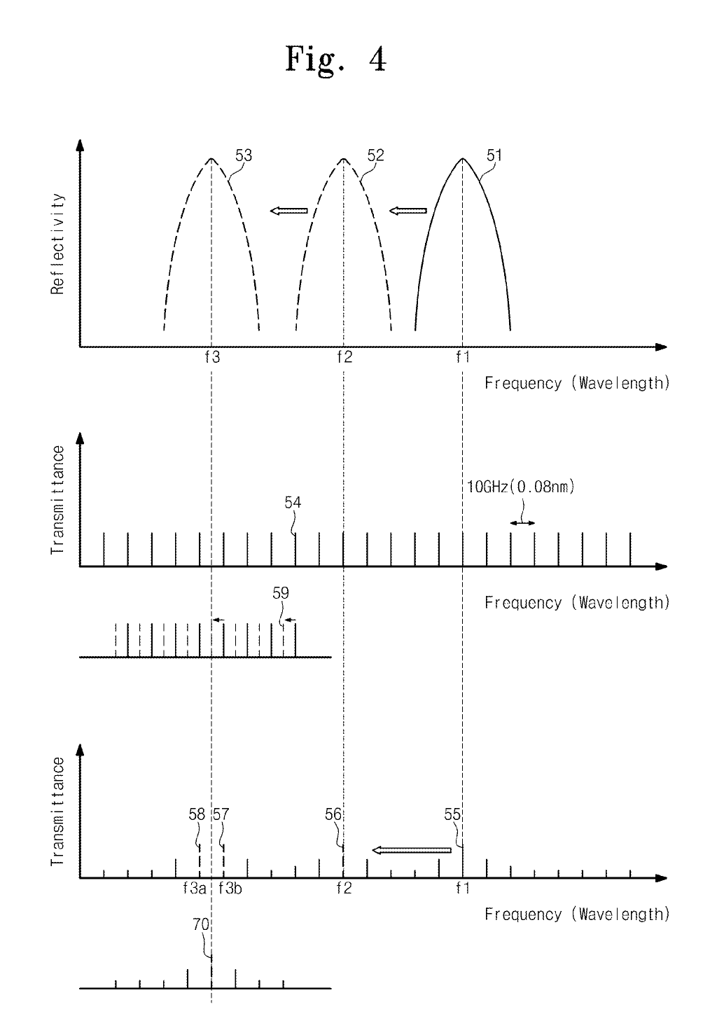

FIG. 4 is graphs illustrating wavelength-tunable characteristics of the laser beam shown in FIGS. 3A to 3C.

Referring to FIGS. 1 and 4, in the PLC device 10 having a predetermined refractive index, first and third reflectivity peaks 51, 52, and 53 may be successively varied depending on a frequency (wavelength) according to current applied to the polymer component. The space of a first Fabry-Perot mode 54 may be varied in according to a resonant length of the ECL. For example, the first Fabry-Perot mode 54 may have a frequency (wavelength) spacing of about 10 GHz (0.08 nm). The PLC device 10 may oscillate laser beam having first and second resonant frequencies 55 and 56 corresponding to the first Fabry-Perot mode 54 within the first and second reflectivity peaks 51 and 52. The first and second reflectivity peaks 51 and 52 may correspond to the first and second resonant frequencies 55 and 56 of which center frequencies accord to the first Fabry-Perot mode 54. On the other hand, since a center frequency of the third reflectivity peak 53 does not accord to the first Fabry-Perot mode 54 of ECL, the third reflectivity peak 53 may be distributed into third and fourth resonant frequencies 57 and 58. Laser beam having the third and fourth resonant frequencies 57 and 58 may have low SMSR characteristics. Here, the laser beam may be generated in a second Fabry-Perot mode 59 by variation of the reflective index due to current applied into the tuning region 1b of the 2-section SLD 1 to oscillate laser beam having a fifth resonant frequency 70.

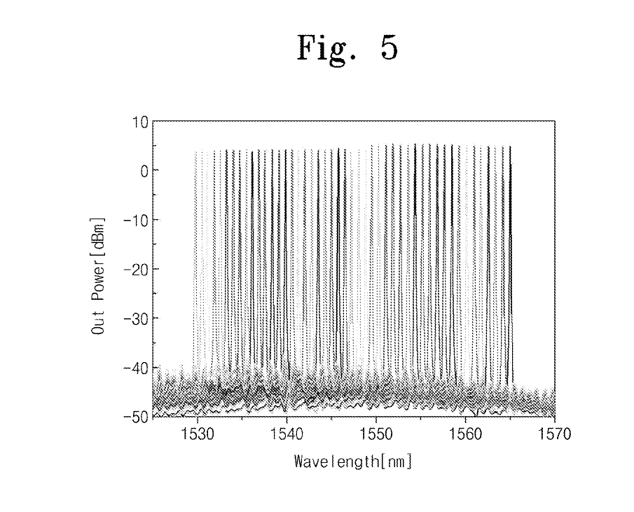

FIG. 5 is a view illustrating wavelength-tunable characteristics of ECL obtained from resonant frequencies of FIG. 4. Laser beam oscillated from the wavelength-tunable external cavity laser according to the embodiment of the inventive concept may have 47 channels in frequencies ranging from about 1,565 nm to about 1530 nm with a frequency spacing of about 100 GHz (0.8 nm). Here, the SMSR is greater than about 40 dB.

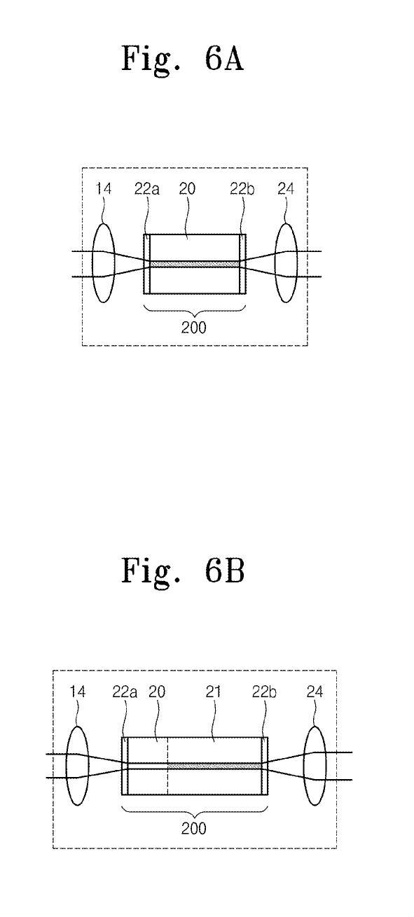

FIGS. 6A and 6B are views of the modulation part. The modulation part 200 may have modulation characteristics of about 10 Gbps when the modulation part 200 is constituted by one EA modulator 20 between the second lens 14 and the third lens 24 or constituted by the SOA 21 and the EA modulator 20 which are monolithically integrated with each other.

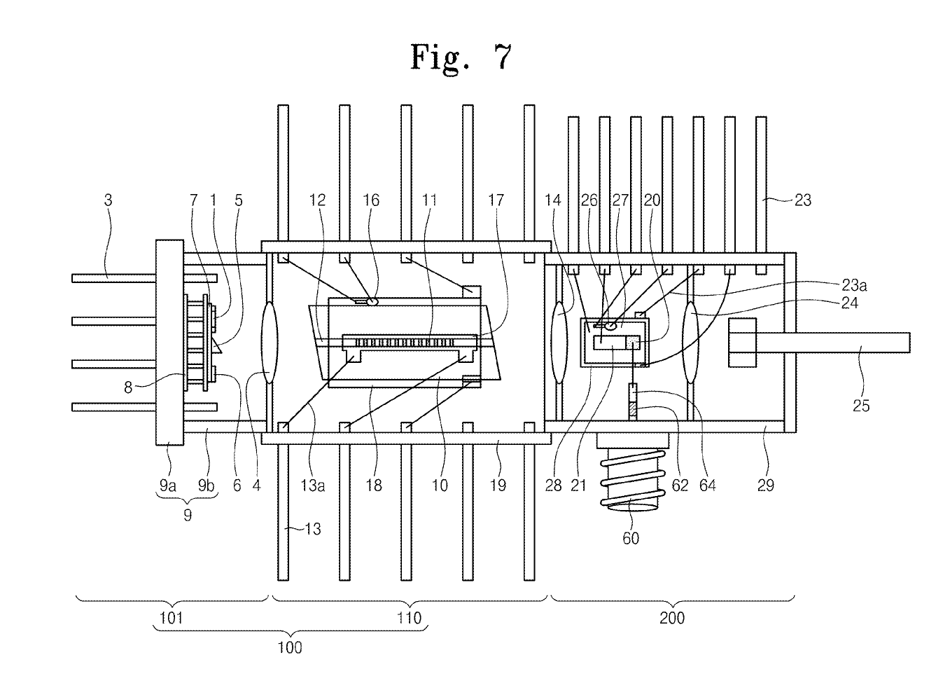

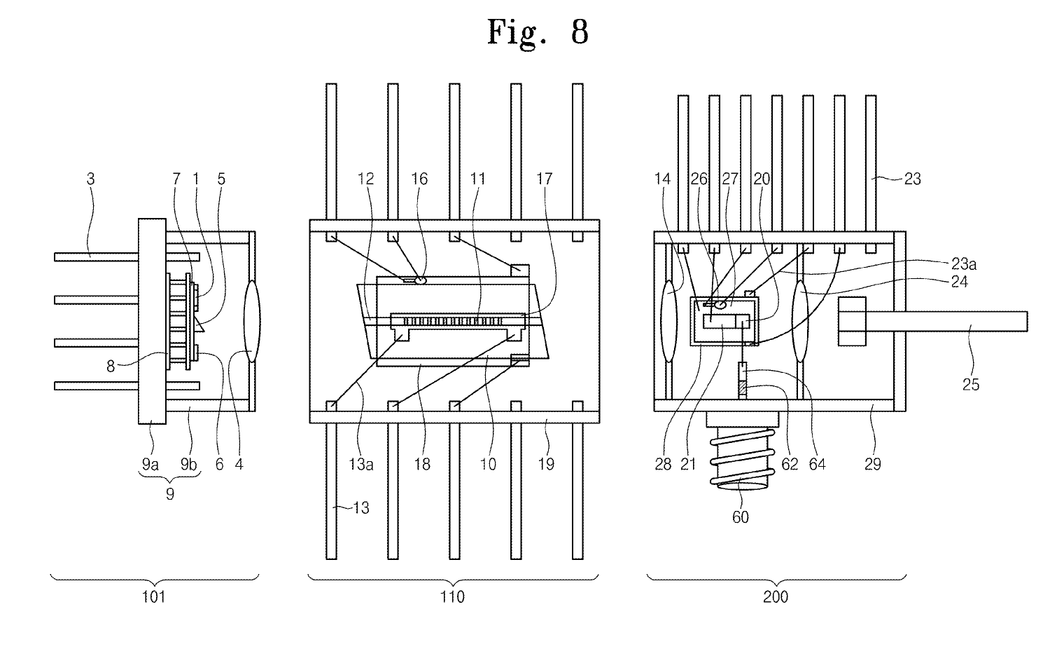

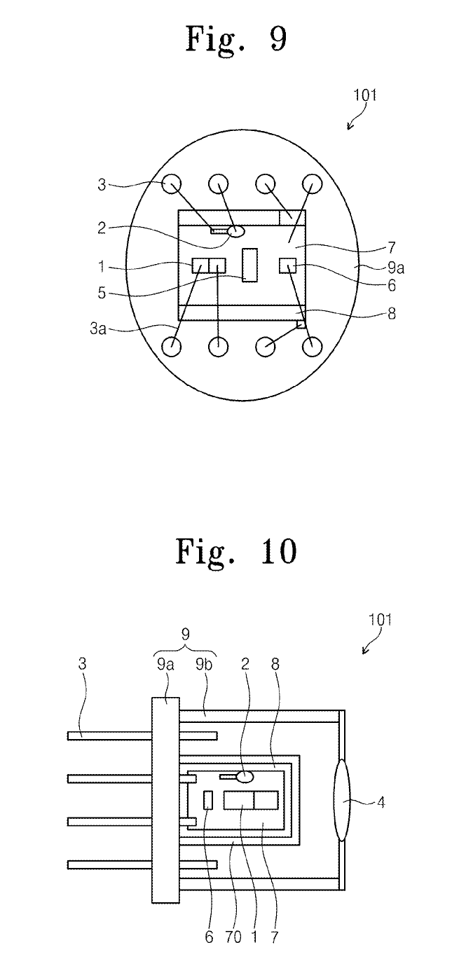

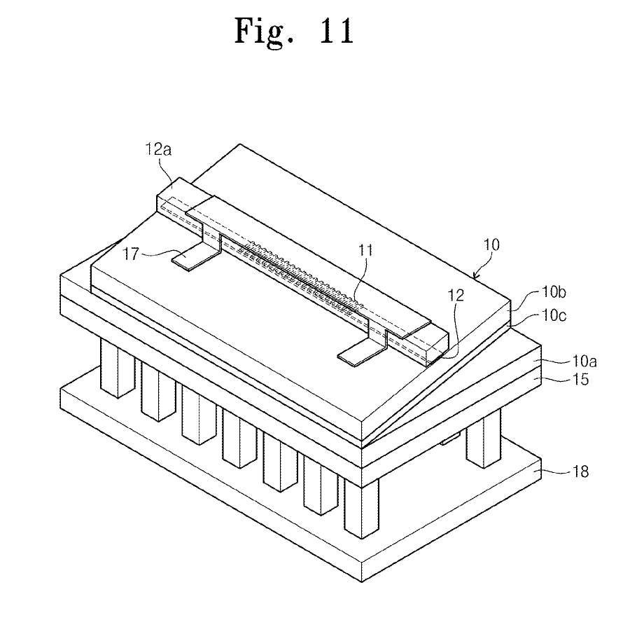

FIGS. 7 and 8 are coupled floor plan and separated floor plan views of a wavelength-tunable ECL according to an application example of the present invention. FIG. 9 is a plan view illustrating a pump light source of a TO-can package of FIG. 7. FIG. 10 is a side view illustrating a pump light source of a TO-can package different from that of FIG. 9. FIG. 11 is a perspective view illustrating a PLC device of FIG. 7.

Referring to FIGS. 1 and 7 to 11, a pump light source 101, a PLC part 110, and a modulation part 200 of a wavelength-tunable ECL according to an application example of the present invention may include first to third housings 9, 19, and 29 which are bonded using laser welding, respectively. The pump light source 101 and the PLC part 110 may constitute an ECL part 100. The pump light source 101 is packaged by a type of TO-can. The TO-can package may include a 2-section SLD 1 generating pump light, a first thermistor 2, a first lead frame 3, an optical detector 6, a first sub-mount 7, a first thermoelectric cooler (TEC) 8, and a first housing 9. The first thermistor 2 and the first TEC 8 may constantly maintain a temperature of the 2-section SLD 1. The first lead frame 3 may be connected to the 2-section SLD 1 and the first thermistor 2 by a first bonding wire 3a. The TO-can package may include a mirror 5 for changing a traveling direction of the pump light. The mirror 5 may change the pump light in a vertical direction from the 2-section SLD 1 to a first lens 4. The mirror 5 may reflect about 90% to about 95% of the pump light.

The first housing 9 may include a package frame 9a and a package cap 9b. The package frame 9a may fix the first sub-mount 7, on which the 2-section SLD 1, the mirror 5, and the optical detector 6 are seated, and first TEC 8 thereto. Also, the first lead frame 3 may pass through the package frame 9a. For example, eight first lead frames 3 may be provided. The package cap 9b may surround the 2-section SLD 1, the mirror 5, and the optical detector 6 on the package frame 9a to fix the first lens 4. The first lens 4 may include an aspherical convex lens for minimally reflecting the pump light.

The PLC part 110 may include a PLC device 10 which oscillates laser beam from the pump light supplied from the pump light source 101 through the first lens 4. The PLC device 10 may include a polymer waveguide 12 in which a Bragg grating 11 having a certain distance therebetween is disposed, upper and lower clads 10b and 10c disposed under the polymer waveguide 12, and an electrode 7 disposed above/under the upper and lower clads 10b and 10c. The polymer waveguide 12 may be disposed under a ridge waveguide layer 12a. As described above, in the PLC device 10, the polymer waveguide 12 may be changed in refractive index by heat generated by current applied into the electrode 17. The PLC device 10 may oscillate wavelength-tunable laser beam as the Bragg grating 11 is varied in reflection peak due to the change of the refractive index of the polymer waveguide 12.

The PLC device 10 may be set to have a constant temperature through a second thermistor 16 and a second TEC 18. A second support block 10a formed of a silicon material and a second sub-mount 15 may be disposed between the PLC device 10 and the second TEC 18. A second housing 19 surrounds the PLC device 10. Also, a second lead frame 13 connected to a second bonding wire 13a bonded to the PLC device 10 may pass through the second housing 19 from the outside thereof into the inside. The second housing 19 may have one side coupled to the first housing 9. The second housing 19 may have the other side coupled to a third housing 29 opposite to the first housing 9.

The modulation part 200 may include an EA modulator 20 and an optical amplifier 21 which are monolithically integrated with each other.

The EA modulator 20 and the SOA 21 may be connected to a third bonding wire 23a. The third housing 29 may fix a second lens 14 between the optical amplifier 21 and the PLC device 10 and a third lens 24 between the EA modulator 20 and an optical fiber 25. A third lead frame 23 and the optical fiber 25 may pass through the third housing 29. A RF-(radio frequency) connector 60 may be connected to the other side of the third housing 29 which faces the third lead frame 23. The RF connector 60 may be connected to a RF frame 64 extending outward from the inside of the third housing 29. An impedance matching resistor 62 may be connected between the RF frame 64 and the RF connector 60.

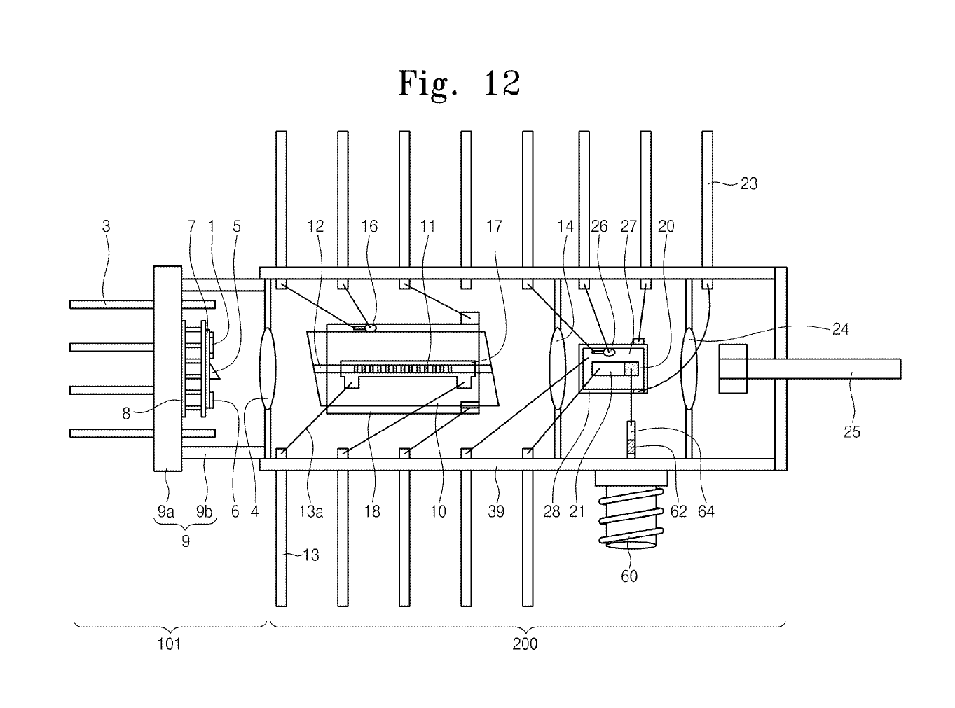

FIG. 12 is a plan view of a wavelength-tunable ECL according to another application example of the present invention.

Referring to FIG. 12, a wavelength-tunable ECL may include a fourth housing 39 surrounding an PLC part 110 and a modulation part 200. The fourth housing 39 may be coupled to a first housing 9. In an application example, a second housing 19 and a third housing 29 may be coupled to each other to form the fourth housing 39.

As described above, according to the embodiment of the inventive concept, the pump light source, the PLC device, and the EA modulator may be disposed within the housing to improve the coupling performance and stability.

Also, the RF connector applying a signal into the EA modulator may be connected to the housing to perform a high speed modulation operation at about 10 Gbps.

The above-disclosed subject matter is to be considered illustrative and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A wavelength-tunable external cavity laser comprising:
a housing;
a planar lightwave circuit (PLC) device disposed within the housing;
a pump light source disposed at a side of the PLC device within the housing; and
a modulation part disposed at the other side of the PLC device facing the pump light source within the housing.

2. The wavelength-tunable external cavity laser of claim 1, wherein the housing comprises first to third housings which respectively surround the pump light source, the PLC device, and the modulation part.

3. The wavelength-tunable external cavity laser of claim 2, further comprising a RF (radio frequency) connector which transmits a RF signal into the modulation part and is coupled to the third housing.

4. The wavelength-tunable external cavity laser of claim 3, further comprising:
a RF lead frame connecting the RF connector to the modulation part within the third housing; and
an impedance matching resistor connected to the RF lead frame.

5. The wavelength-tunable external cavity laser of claim 4, wherein the modulation part comprises an EA modulator.

6. The wavelength-tunable external cavity laser of claim 5, wherein the modulation part further comprises an SOA (semiconductor optical amplifier) monolithically integrated with the EA modulator.

7. The wavelength-tunable external cavity laser of claim 6, wherein the SOA comprises an input perpendicular to an extension line from the pump light source to the PLC device and an output titled with respect to the extension line.

8. The wavelength-tunable external cavity laser of claim 6, wherein the modulation part further comprises anti-reflection coating layers respectively disposed on the peripheries of both sides facing each other of the SOA and the EA modulator.

9. The wavelength-tunable external cavity laser of claim 6, wherein the modulation part further comprises a thermoelectric cooler (TEC) and a thermistor to constantly maintain temperatures of the SOA and the EA modulator.

10. The wavelength-tunable external cavity laser of claim 2, wherein the pump light source comprises a thermo-optic (TO)-can package comprising a 2-section superluminescent diode (SLD) disposed on a package frame.

11. The wavelength-tunable external cavity laser of claim 10, wherein the first housing comprises a package cap surrounding the package frame and the 2-section SLD disposed on the package frame.

12. The wavelength-tunable external cavity laser of claim 10, wherein the 2-section SLD comprises a gain region and a micro tuning region.

13. The wavelength-tunable external cavity laser of claim 12, wherein the gain region and the micro tuning region are tilted at an angle of about 5° to about 15°.

14. The wavelength-tunable external cavity laser of claim 10, wherein the TO-can package comprises a mirror changing a traveling path of pump light from the 2-section SLD to the PLC device.

15. The wavelength-tunable external cavity laser of claim 2, wherein the PLC device comprises a polymer waveguide comprising a Bragg grating.

16. The wavelength-tunable external cavity laser of claim 1, wherein the housing comprises a first housing surrounding the pump light source and a fourth housing surrounding the PLC device and the modulation part.

17. The wavelength-tunable external cavity laser of claim 1, wherein the PLC device have ridge waveguide structure to enhance the injection current efficiency in PLC device.
